(19) United States
(12) Patent Application Publication
(10) Pub. No.: US 2021/0065241 A1
(43) Pub. Date: Mar. 4, 2021

(54) VEHICLE TIME-MULTIPLEXED DISPLAY

(71) Applicant: Ford Global Technologies, LLC, Dearborn, MI (US)

(72) Inventor: Punarjay Chakravarty, Campbell, CA (US)

(73) Assignee: Ford Global Technologies, LLC, Dearborn, MI (US)

(21) Appl. No.: 16/559,205

(22) Filed: Sep. 3, 2019

(51) Int. Cl. G06Q 30/02

(52) U.S. Cl. CPC G06Q 30/0266; G06Q 30/0261

(57) ABSTRACT

A system comprising a computer that includes a processor and a memory. The memory stores instructions executable by the processor to actuate a digital display on a vehicle to display a first set of content for more than an amount of time determined to render the first set of content detectable for a human, and to actuate the digital display to display a second set of content immediately after and immediately before the first set of content for less than the amount of time.

### BACKGROUND

Vehicles can be equipped to operate in both autonomous and occupant piloted mode. Vehicles can be equipped with computing devices, networks, sensors and controllers to acquire information regarding the vehicle's environment and to operate the vehicle based on the information. Safe and comfortable operation of the vehicle can depend upon acquiring accurate and timely information regarding the vehicle's environment. Vehicle sensors can provide data concerning routes to be traveled and objects to be avoided in the vehicle's environment. Safe and efficient operation of the vehicle can depend upon acquiring accurate and timely information regarding routes and objects in a vehicle's environment while the vehicle is being operated on a roadway.

### BRIEF DESCRIPTION OF THE DRAWINGS

FIG. 1 shows an exemplary vehicle and a stationary camera sensor.

FIG. 2 shows a perspective view of the vehicle of FIG. 1 with example orientation vectors superimposed thereon.

FIG. 3 is a diagram of example fiducial marks.

FIG. 4 is an exemplary graph showing time-multiplexed first and second image frames.

FIG. 5 illustrates a flowchart of an exemplary process for operating the vehicle.

### DETAILED DESCRIPTION

### Introduction

Disclosed herein is a system, comprising a computer that includes a processor and a memory. The memory stores instructions executable by the processor to actuate a digital display on a vehicle to display a first set of content for more than an amount of time determined to render the first set of content detectable for a human, and to actuate the digital display to display a second set of content immediately after and immediately before the first set of content for less than the amount of time.

The first set of content may include a plurality of frames, and the second set of content may include a single frame.

The amount of time may be one-hundred milliseconds.

The second content may include a marker identifying the vehicle.

The instructions may further include instructions to receive a pose of the vehicle from a remote computer, wherein the remote computer is programmed to receive image data from a camera sensor, including a vehicle marker in the second set of content, and to transmit the vehicle pose to the computer.

The instructions may further include instructions to navigate the vehicle based at least in part on the vehicle pose.

The instructions may further include instructions to determine whether data received from the remote computer includes the vehicle pose based on the displayed second set of content.

The instructions may further include instructions to generate the second set of content based on a vehicle identifier and the remote computer may be further programmed to decode the vehicle identifier based on the received second set of content and include the vehicle identifier in the transmitted vehicle pose.

The instructions may further include instructions to generate the second set of content based on vehicle diagnostics data.

The instructions may further include instructions to actuate the digital display to display the first set of content for an amount of time greater than multiple of time determined to render the first set of content detectable for the human.

The instructions may further include instructions to generate the second set of content further based on a position of the digital display on the vehicle, to generate a third set of content based on a second digital display position on the vehicle, to actuate the second digital display on the vehicle to display the first set of content for more than the amount of time determined to render the first set of content detectable for the human, and to actuate the second digital display to display the third set of content immediately after and immediately before the first set of content for less than the amount of time, wherein the remote computer is further programmed to determine the vehicle pose further based on the third set of content displayed on the second digital display.

Further disclosed herein is a system comprising means for displaying on a vehicle a first set of content for more than an amount of time determined to render the first set of content detectable for a human and displaying a second set of content immediately after and immediately before the first set of content for less than the amount of time, means for receiving a pose of the vehicle from a remote computer based on the displayed second set of content, and means for operating the vehicle based on the received pose of the vehicle.

Further disclosed herein is a method, comprising actuating a digital display on a vehicle to display a first set of content for more than an amount of time determined to render the first set of content detectable for a human; and actuating the digital display to display a second set of content immediately after and immediately before the first set of content for less than the amount of time.

The first set of content may include a plurality of frames, and the second set of content includes a single frame.

The amount of time may be one-hundred milliseconds.

The second set of content may include a marker identifying the vehicle.

The method may further include receiving, in a remote computer, image data from a camera sensor, including a vehicle marker in the second set of content, transmitting a vehicle pose to a vehicle computer, receiving, in the vehicle computer, a pose of the vehicle from a remote computer, and navigating the vehicle based at least in part on the vehicle pose.

The method may further include determining whether data received from the remote computer includes the vehicle pose based on the displayed second set of content.

The method may further include generating the second set of content based on a vehicle identifier, decoding, in a remote computer, the vehicle identifier based on the received second set of content, and including the vehicle identifier in the transmitted vehicle pose.

The method may further include generating the second set of content based on vehicle diagnostics data.

Further disclosed is a computing device programmed to execute any of the above method steps. Yet further disclosed is an aerial drone comprising the computing device. Yet further disclosed is a vehicle comprising the computing device.

Yet further disclosed is a computer program product comprising a computer readable medium storing instructions executable by a computer processor, to execute the any of the above method steps.

### System Elements

Vehicle sensors can provide data concerning routes to be traveled and objects to be avoided in the vehicle's environment. In order to operate the vehicle on a route, the computer determines a vehicle path based at least on an actual vehicle location and orientation. However, vehicle sensors for providing data about a vehicle's environment may be inefficient, unavailable, etc. As disclosed herein, a remote computer can determine and provide a vehicle's location and/or orientation from based on data received from stationary sensors outside the vehicle with a field of view including the vehicle. The stationary sensor may determine vehicle's location and/or orientation based on image data, e.g., including a marker, displayed on the vehicle exterior.

In one example, to provide the image data to remote sensors, a vehicle computer can be programmed to actuate a digital display on a vehicle exterior to display a plurality of first frames including a first set of content and one or more second frames including a second set of content. The first frames are displayed for a majority of cycles such that at least two first frames are displayed consecutively for more than 100 milliseconds (ms), and the one or more second frames are each displayed immediately after and immediately before one of the first frames for less than 100 ms.

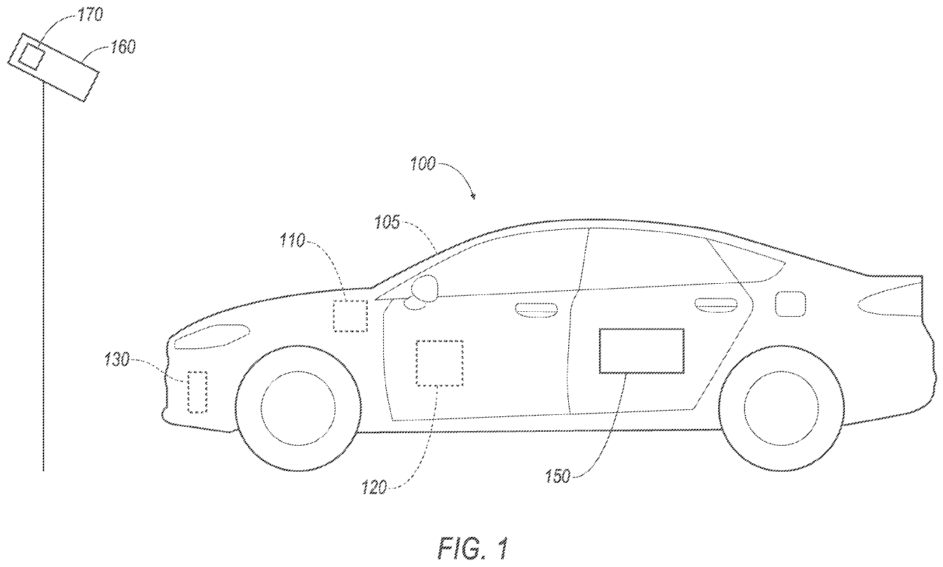

FIG. 1 illustrates an example vehicle 100 including a computer 110, actuator(s) 120, sensor(s) 130, and other components discussed herein below. The vehicle 100 may be powered in a variety of known ways, e.g., including with an electric motor and/or internal combustion engine. A reference point 140 can be defined for a vehicle 100, e.g., a geometrical center point (i.e., a point of intersection of bisecting longitudinal, lateral, and vertical axes) of the vehicle 100. The vehicle 100 includes a body 105 that may be formed of metal, plastic, composite material, and/or any other suitable material, etc. The vehicle 100 includes one or more digital displays 150 mounted to an exterior surface of the body 105, e.g., e.g., mounted to a side, front, rear, or top of the vehicle 100 body 105.

The computer 110 includes a processor and a memory such as are known. The memory includes one or more forms of computer-readable media, and stores instructions executable by the computer 110 for performing various operations, including as disclosed herein.

The computer 110 may operate the vehicle 100 in an autonomous or semi-autonomous mode. For purposes of this disclosure, an autonomous mode is defined as one in which each of vehicle 100 propulsion, braking, and steering are controlled by the computer 110; in a semi-autonomous mode the computer 110 controls one or two of vehicle 100 propulsion, braking, and steering; in a non-autonomous mode, a human operator controls vehicle propulsion, braking, and steering.

The computer 110 may include programming to operate one or more of vehicle brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer 110, as opposed to a human operator, is to control such operations.

The computer 110 may include or be communicatively coupled to, e.g., via a vehicle communications bus as described further below, more than one processor, e.g., controllers or the like included in the vehicle for monitoring and/or controlling various vehicle controllers, e.g., a powertrain controller, a brake controller, a steering controller, etc. The computer 110 is generally arranged for communications on a vehicle communication network such as a bus in the vehicle such as a controller area network (CAN) or the like.

Via the vehicle network, the computer 110 may transmit messages to various devices in the vehicle and/or receive messages from the various devices, e.g., sensor(s) 130, actuator(s) 120, etc. Alternatively or additionally, in cases where the computer 110 actually comprises multiple devices, the vehicle communication network may be used for communications between devices represented as the computer 110 in this disclosure. Further, as mentioned below, various controllers and/or sensors may provide data to the computer 110 via the vehicle communication network.

The vehicle 100 actuators 120 may be implemented via circuits, chips, or other electronic components that can actuate various vehicle subsystems in accordance with appropriate control signals as is known. The actuators 120 may be used to control braking, acceleration, and steering of the first vehicle 100. As an example, the vehicle 100 computer 110 may output control instructions to control the actuators 120.

The computer 110 may be configured for communicating through a vehicle-to-vehicle (V-to-V) wireless communication interface with other vehicles, e.g., via a vehicle-to-vehicle communication. The V-to-V or V-to-X communication represents one or more mechanisms by which vehicle 100 computers 110 may communicate with other vehicles 100 and/or infrastructure element, e.g., a computer 170 in a stationary camera 160, and may be one or more of wireless communication mechanisms, including any desired combination of wireless and wired communication mechanisms and any desired network topology (or topologies when a plurality of communication mechanisms are utilized). Exemplary V-to-V communication protocols include cellular, Bluetooth, IEEE 802.11, dedicated short-range communications (DSRC), and/or wide area networks (WAN), including the Internet, providing data communication services. DSRC may include one-way or two-way short-range to medium-range wireless communication channels.

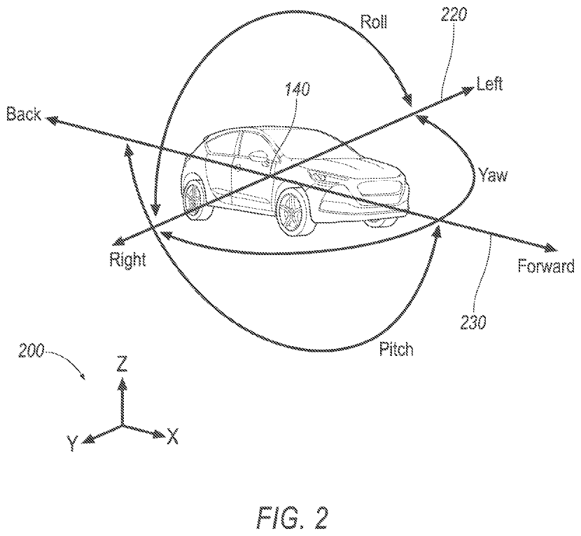

Vehicle 100 sensors 130 may provide data from sensing at least some of an exterior of the vehicle 100, e.g., a GPS (Global Positioning System) sensor, camera, radar, and/or lidar (light imaging detection and ranging). With reference to FIGS. 1-2, the computer 110 may be programmed to determine a pose of the vehicle 100 based on data received from the vehicle 100 sensor(s) 130, e.g., lidar sensor 130, GPS sensor 130, yaw rate sensor 130, accelerometer sensor 130, etc. Additionally or alternatively, the computer 110 may be programmed to receive the vehicle 100 pose data from a remote computer, e.g., a stationary camera 160 computer 170. In the present context, a pose (or six degree of freedom pose) of the vehicle 100 is a set of data defining a location and orientation of the vehicle 100. The location may be specified by location coordinates (x, y, z) of the vehicle 100 with respect to a three-dimensional (3D) coordinate system 200. The location coordinates system 200 may be a Cartesian coordinate system including X, Y, and Z axes. The location coordinate system 200 has an origin point, e.g., a global positioning system (GPS) reference point. An orientation of the vehicle 100 is specified by a set of data including a roll, pitch, and yaw of the vehicle 100. The roll, pitch, and yaw may be specified as angles with respect to axes 220, 230 which intersect at the vehicle 100 reference point 140 and a plane including the axes 220, 230 may be parallel to the ground surface.

The vehicle 100 computer 110 may be programmed to operate the vehicle 100 based at least in part on the vehicle 100 pose. For example, the computer 110 may be programmed to identify objects such as road edge(s), buildings, intersections, etc., based on the determined vehicle 100 pose and received map data. A 3D map of an area, in the context of the present disclosure, is a digital map including 3D location coordinates of points on surfaces, e.g., a road surface, traffic signs, buildings, vegetation, etc., within the mapped area. An area is a portion of the ground surface, e.g., a road, a neighborhood, etc. Location coordinates of a point in area, e.g., a point on a road surface, may be specified by X, Y, and Z coordinates, e.g., in a Cartesian coordinate system 200. X and Y coordinates, i.e., horizontal coordinates, may be, e.g., global positioning system (GPS) coordinates (i.e., latitude and longitude coordinates) or the like, and a Z coordinate may specify a vertical component to a location, i.e., a height (or elevation) of a point from a specified horizontal reference plane, e.g., sea or ground level. The computer 110 may be programmed to determine a vehicle path based on the vehicle 100 pose, map data, and object data specifying location, dimensions, etc. of obstacles on the vehicle path.

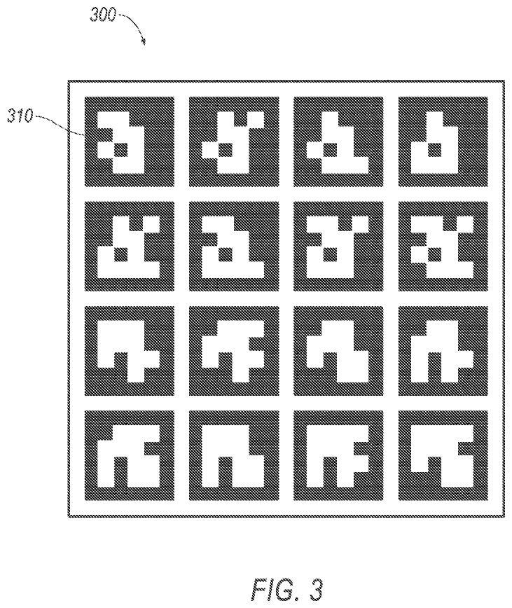

The vehicle 100 includes one or more digital display(s) 150. A display 150 may be implemented using chips, electronic components, and/or light emitting diode (LED), liquid crystal display (LCD), organic light emitting diode (OLED), etc. The display 150 may be attached to an exterior surface of the vehicle 100 or may be manufactured to be a part of the exterior surface of the body 105. The display 150 may receive image frames from the computer 110, e.g., via a vehicle communication network, etc. A display 150 typically has a refresh rate which may be specified in frames per second (fps) or Hertz (Hz). For example, the display 150 may have a refresh rate of 30 fps or 30 Hz (i.e., replacing/refreshing a displayed image frame 30 times per second). In one example, the computer 110 may be programmed to transmit a sequence of image frames to the display 150 based on the refresh rate of the display 150, e.g., transmitting a set of 30 image frames each second to the display 150, as discussed with reference to FIG. 3. In another example, the computer 110 may be programmed to send image frame data with associated time stamps and the display 150 may be configured (e.g., having a processor programmed) to output the received image frames based on the time stamp of each image frame.

With continued reference to FIG. 1, the vehicle 100 may be within a field of view of a camera sensor 160 that is stationary, e.g., mounted to a pole, positioned on a non-moving truck, mounted to a building, etc. The camera sensor 160 may include a computer 170 programmed to receive image data and determine a vehicle 100 pose. Making camera sensor 160 stationary permits a computer, e.g., camera sensor 160 computer 170, to acquire data regarding the pose of the camera sensor 160 with respect to, e.g., the 3D global coordinate system 200. The pose of the camera sensor 160 can be combined with data regarding the location of a field of view of video camera 160, as described further below. For example, data regarding the magnification of a lens included in camera sensor 160 can be combined with map data regarding the locations of portions in field of view to determine a transformation based on projective geometry that transforms poses in pixel coordinates to global coordinates. A transformation to transform pixel coordinates to global coordinates can also be determined by acquiring image data regarding fiducial markers 300 in the field of view and measuring the fiducial markers 300, for example. Determining a transform to transform pixel coordinates to global coordinates for a camera sensor 160 can be described as calibrating the camera sensor 160.

The computer 170 may be programmed to determine a pose of a vehicle 100 with respect to the coordinate system 200 based on the received image data, location coordinates and pose of the stationary camera sensor 160, and received map data. In one example, the computer 170 may be programmed to determine a pose of the vehicle 100 based on one or more fiducial markers 300 (FIG. 3) displayed on the vehicle 100 display(s) 150.

FIG. 3 is a diagram of an example fiducial marker 300. A fiducial marker 300 is an object placed in the field of view of an imaging system which appears in the image produced, for use as a point of reference or a measurement. For example, a fiducial marker 300 can include a number of ArUco fiducial marks 310. ArUco fiducial marks 310 are two-dimensional (2D) patterns from a library of fiducial marks described at www.uco.es/grupos/ava/node/26, “Aplicaciones de la Vision Artificial”, University of Cordoba, Spain, May 15, 2019. ArUco fiducial marks are designed to be read by machine vision software that can determine a pose in pixel coordinates for each ArUco fiducial mark 310 included in a fiducial marker 300 by processing a 2D (two-dimensional) image of the fiducial marker 300.

A fiducial maker 300 can be used to determine a pose of a vehicle 100 using a stationary camera sensor 160 by displaying the fiducial marker 300 on the vehicle 100. For example, a vehicle 110 display 150 mounted on a vehicle 100 roof, door, etc., can display a fiducial marker 300. When the vehicle 100 passes into the field of view of a stationary camera sensor 160, an image (or a video image) of the vehicle 100 including the fiducial marker 300 can be acquired and the computer 170 can determine a 3D pose of the fiducial marker 300 by using machine vision software. The computer 170 may be programmed to transmit vehicle 100 pose data to the vehicle 100, e.g., via a V-to-X wireless communication network, as described above.

By determining a pose for each fiducial mark 310 included in an image of a fiducial marker 300, the computer 170 can determine a pose of the vehicle 100 on which the fiducial marker 300 is displayed by the vehicle 100 display 150. For example, the computer 170 may be programmed to determine a pose of the vehicle 100 using a convolutional neural network (CNN). A CNN is a software program that can be implemented on a computing device that can be trained to input an image of a vehicle 100 and output a vehicle 100 pose in response. A CNN includes a plurality of convolutional layers that extract hidden features from input image of a vehicle 100 which are passed to a plurality of fully-connected layers that transform the hidden features into a vehicle 100 pose. A CNN can be trained to perform vehicle 100 pose processing by processing a plurality of images of vehicles 100 including the displayed fiducial marker(s) 300 to determine a vehicle 100 pose. The determined pose of the vehicle, e.g., using vehicle 100 LIDAR sensor 130, location sensor 130, etc., is defined as “ground truth,” because it was determined independently from the CNN. The CNN is trained by inputting an image of a vehicle 100 captured by the camera 160 and backpropagating results to be compared with the ground truth pose to determine a loss function. Training the CNN includes determining parameters for convolutional and fully-connected layers that minimize the loss function. When trained, a CNN can input an image of a vehicle 100 received from the stationary sensor 160 and output a pose, e.g., with respect to the camera sensor 160. As discussed above, the pose can be transformed into, i.e., described with respect to, global coordinates, e.g., coordinate system 200, by combining the output pose of the CNN and a pose of the stationary camera sensor 160 and data regarding the field of view.

The vehicle 100 computer 110 may be programmed to embed a vehicle 100 identifier, e.g., a license plate number, into the fiducial marker 300 displayed on the respective vehicle 100. Thus, the fiducial marker 300 may identify the vehicle 100 on which the marker 300 is displayed. In other words, a vehicle 100 identifier can be decoded from the fiducial marker 300. The computer 170 may be programmed to decode the vehicle 100 identifier from the fiducial marker 300 displayed on the vehicle 100 and to broadcast via the wireless network the vehicle 100 pose data including the vehicle 100 identifier and the respective pose data. Thus, a vehicle 100 computer 110 receiving vehicle pose data and a respective vehicle identifier may be programmed to determine, based on a stored vehicle 100 identifier, whether the received pose data is the pose data of ego vehicle 100 or pose data of a second vehicle 100. The computer 110 may be programmed to operate the vehicle 100 based on the received pose data upon determining that the received pose data is the respective vehicle 100 pose data.

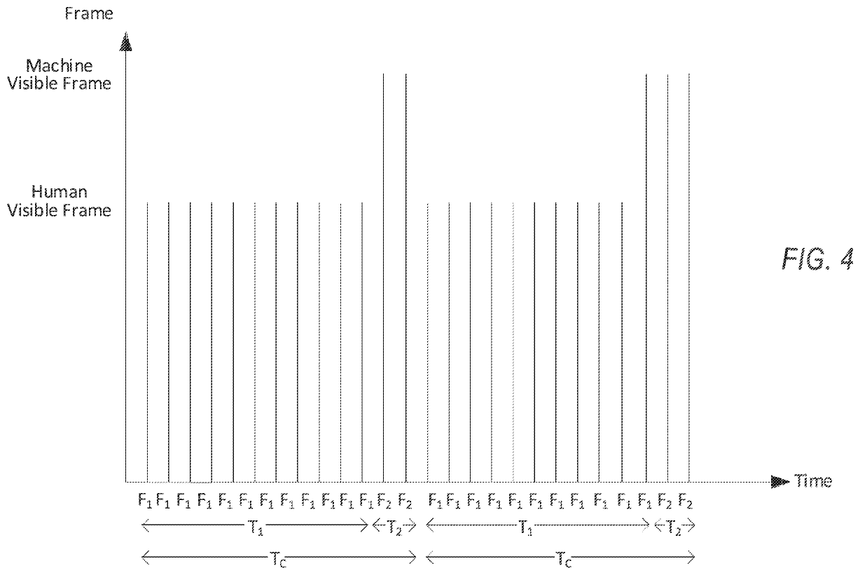

With reference to FIGS. 1 and 4, the computer 110 may be programmed to actuate a digital display 150 on a vehicle 100 to display a plurality of first frames F₁ including a first set of content and one or more second frames F₂ including a second set of content. A time duration for displaying the first and second sets of content can be determined based on an amount of time generally known for displaying content to be detected—or not detected—by a human eye. That amount of time is generally known to be substantially 100 ms. The first frames F₁ are displayed for a majority of cycles T_{C} such that at least two first frames F₁ are displayed consecutively for a first time duration T₁ that is more than 100 ms, and the one or more second frames F₂ are each displayed immediately after and immediately before, i.e., with no intervening frames, one of the first frames F₁ for a second time duration T₂ that is less than 100 ms. In one example, the first time T₁ may be specified to be less than a threshold, e.g., 100 ms, whereas the second time T₂ may be greater than a second threshold that is multiple, e.g., 5 times, of the amount of time determined to render the first set of content detectable for human vision. Thus, a likelihood of human vision detecting the first set of content may be improved. In one example shown in FIG. 4, the first and second content may be displayed periodically with a cycle time T_{C}.

For example, with a refresh rate of 30 Hz and a cycle time T_{C} of 1 second, the 18 first frames may be displayed for a first time duration T₁ of 934 ms, and two of second frames F₂ may be displayed for a second time duration T₂ of 66 ms, thus the first content included in the first frames is displayed most of the time compared to the second content included in the second frames. Human vision typically recognizes (or renders as detectable) an image when viewed for more than 100 ms. On the other hand, a camera sensor 160 may include an imaging sensor that allows detection of images displayed for less than 100 ms, e.g., a camera sensor may sample 100 images per second and thus may capture an image that is shown for more than 10 ms. Thus, the computer 170 may be programmed to detect the first and second set of contents whereas a human eye may recognize the first set of content.

The second set of content may include a marker such as a fiducial marker 300 (FIG. 3) identifying the vehicle 100. The first set of content may include conventional still or moving images (e.g., a vehicle 100 can be used to provide an advertisement, textual information, a logo, etc.). Thus, a human observer outside the vehicle 100, e.g., a pedestrian, may see and recognize the first content, e.g., the advertisement, while not recognizing the second content, e.g., the marker 300. As discussed above, the computer 170 may be programmed to determine the pose of the vehicle 100 based on the second content, e.g., the fiducial marker 300, and to broadcast the vehicle 100 pose and the vehicle 100 identifier via a wireless communication network. For example, using a CNN, as discussed above, the computer 170 may be programmed to determine the pose of the vehicle 100 based on the image data including the fiducial marker 300. The computer 170 may be programmed to broadcast data including the pose of the vehicle 100 via a wireless network. The vehicle 100 computer 110 may be programmed to receive a pose of the vehicle 100 from a remote computer, e.g., the computer 170, and to navigate the vehicle based at least in part on the vehicle 100 pose.

As discussed above, the second set of data may include a fiducial marker 300 that identifies the vehicle 100. Additionally or alternatively, the vehicle 100 computer 110 may be programmed to generate the second set of content based on vehicle 100 diagnostics data. For example, the vehicle 100 computer 110 may include information in the second set of data specifying a malfunction of a vehicle 100 sensor 130, actuator 120, controller, etc. Thus, the camera sensor 160 computer 170 may decode diagnostics information of vehicle(s) 100. In one example, the computer 170 may be programmed, upon detecting a malfunction in a vehicle 100 based on the detected diagnostics data in the vehicle 100 second set of content, to broadcast messages to the vehicle 100 within proximity (e.g., within 500 meters) of the respective stationary camera 160. Diagnostics data include information about the state of vehicle 100 components, e.g., whether a component is operating as expected or not. For example, the computer 110 may be programmed to encode data into a mark 310 by providing a marker shape and/or pattern based on numerical data such as license plate number, a diagnostic trouble code (DTC), etc., and the computer 170 may be programmed to determine the numerical data based on the shape and/or pattern of markers 310 included in the fiducial marker 300.

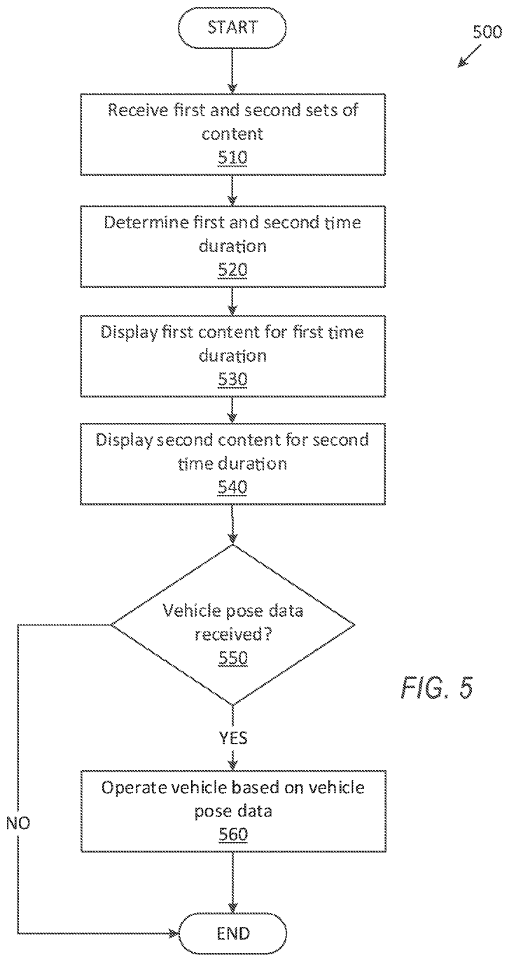

FIG. 5 is a flowchart of an exemplary process 500 for operating the vehicle 100. The vehicle 100 computer 110 may be programmed to execute blocks of the process 500.

The process 500 begins in a block 510, in which the computer 110 stores first and second sets of content in a computer 110 memory. The first set of content may include visual and/or textual information such as an advertisement for displaying to a human or a machine, e.g., a camera sensor 160. The computer 110 may be programmed to receive the first set of content via conventional data transfers mechanisms, e.g., from a remote computer via a wireless network, from a peripheral device attachable to the computer 110, etc. The computer 110 may be programmed to generate the second set of content such as a fiducial marker 300 based on a vehicle 100 identifier and/or vehicle 100 diagnostics data. In one example, the vehicle 100 may include a first and a second display 150 mounted in a first and a second position on the vehicle 100 body 105 relative to the vehicle 100 reference point 140. The computer 110 may be programmed to display a first fiducial marker 300 generated based at least in part on the first position (e.g., a door) and a second fiducial marker 300 generated based at least in part on the second position (e.g., a hood).

Next, in a block 520, the computer 110 determines first and second time durations T₁, T₂ for displaying the first and second image frames F₁, F₂ including the first and second sets of content. The first time duration T₁ is more than 100 ms. The second time duration T₂ is less than 100 ms. In one example, the time durations T₁, T₂ are stored in a computer 110 memory.

Next, in a block 530, the computer 110 actuates a display 150 to display a plurality of first frames F₁ including the first set of content for the first time duration T₁. Alternatively, the computer 110 may be programmed to display the first frame F₁ for the first time duration T₁. Thus, the first set of content may be displayed uninterrupted for the first time duration T₁.

Next, in a block 540, the computer 110 actuates a display 150 to display one or more second frames F₂ including the second set of content for the second time duration T₂. Alternatively, the computer 110 may be programmed to display the second frame F₂ for second time duration T₂. Thus, the second set of content may be displayed uninterrupted for the second time duration T₂. In one example, the computer 110 may be programmed to display 150 a first fiducial marker 300 on a first display 150 for the second time duration T₂ and a second fiducial marker 300 on a second display 150 for the second time duration T₂.

Next, in a decision block 550, the computer 110 determines whether vehicle 100 pose data is received from a remote computer. The computer 110 may be programmed to determine whether vehicle 100 pose data is received via the wireless network, e.g., a vehicle-to-vehicle communication network, from a camera sensor 160 computer 170, and/or an infrastructure computer coupled to the camera sensor 160 computer 170. For example, the computer 110 may receive the pose data via a vehicle 100 wireless communication interface. The computer 110 may be programmed to determine whether the received pose data provides a pose of the vehicle 100 based on the vehicle 100 stored identifier and a matching identifier included in the received pose data. If the computer 110 determines that pose data of the vehicle 100 is received, then the process 500 proceeds to a block 560; otherwise the process 500 ends, or alternatively returns to the block 510, although not shown in FIG. 5.

In the block 560, the computer 110 operates the vehicle 100 based at least in part on the received vehicle 100 pose. The computer 110 may determine a vehicle path upon which to operate the vehicle 100 based on the location and orientation included in the pose of the vehicle 100. The computer 110 may operate the vehicle 100 on a vehicle path by controlling vehicle powertrain, steering and brake actuators 120. Following the block 560 the process 500 ends, or alternatively returns to the block 510.

Computing devices as discussed herein generally each include instructions executable by one or more computing devices such as those identified above, and for carrying out blocks or steps of processes described above. Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in the computing device is generally a collection of data stored on a computer readable medium, such as a storage medium, a random-access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random-access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

What is claimed is:

1. A system, comprising a computer that includes a processor and a memory, the memory storing instructions executable by the processor to:
actuate a digital display on a vehicle to display a first set of content for more than an amount of time determined to render the first set of content detectable for a human; and
actuate the digital display to display a second set of content immediately after and immediately before the first set of content for less than the amount of time.

2. The system of claim 1, wherein the first set of content includes a plurality of frames, and the second set of content includes a single frame.

3. The system of claim 1, wherein the amount of time is one-hundred milliseconds.

4. The system of claim 1, wherein the second content includes a marker identifying the vehicle.

5. The system of claim 1, wherein the instructions further include instructions to receive a pose of the vehicle from a remote computer, wherein the remote computer is programmed to receive image data from a camera sensor, including a vehicle marker in the second set of content, and to transmit the vehicle pose to the computer.

6. The system of claim 5, wherein the instructions further include instructions to navigate the vehicle based at least in part on the vehicle pose.

7. The system of claim 5, wherein the instructions further include instructions to determine whether data received from the remote computer includes the vehicle pose based on the displayed second set of content.

8. The system of claim 7, wherein the instructions further include instructions to generate the second set of content based on a vehicle identifier and the remote computer is further programmed to decode the vehicle identifier based on the received second set of content and include the vehicle identifier in the transmitted vehicle pose.

9. The system of claim 1, wherein the instructions further include instructions to generate the second set of content based on vehicle diagnostics data.

10. The system of claim 1, wherein the instructions further include instructions to actuate the digital display to display the first set of content for an amount of time greater than multiple of time determined to render the first set of content detectable for the human.

11. The system of claim 1, wherein the instructions further include instructions to:
generate the second set of content further based on a position of the digital display on the vehicle;
generate a third set of content based on a second digital display position on the vehicle;
actuate the second digital display on the vehicle to display the first set of content for more than the amount of time determined to render the first set of content detectable for the human; and
actuate the second digital display to display the third set of content immediately after and immediately before the first set of content for less than the amount of time; wherein the remote computer is further programmed to determine the vehicle pose further based on the third set of content displayed on the second digital display.

12. A system, comprising:
means for displaying on a vehicle a first set of content for more than an amount of time determined to render the first set of content detectable for a human and displaying a second set of content immediately after and immediately before the first set of content for less than the amount of time;
means for receiving a pose of the vehicle from a remote computer based on the displayed second set of content; and
means for operating the vehicle based on the received pose of the vehicle.

13. A method, comprising:
actuating a digital display on a vehicle to display a first set of content for more than an amount of time determined to render the first set of content detectable for a human; and
actuating the digital display to display a second set of content immediately after and immediately before the first set of content for less than the amount of time.

14. The method of claim 13, wherein the first set of content includes a plurality of frames, and the second set of content includes a single frame.

15. The method of claim 13, wherein the amount of time is one-hundred milliseconds.

16. The method of claim 13, wherein the second set of content includes a marker identifying the vehicle.

17. The method of claim 13, further comprising:
receiving, in a remote computer, image data from a camera sensor, including a vehicle marker in the second set of content;
transmitting a vehicle pose to a vehicle computer;
receiving, in the vehicle computer, a pose of the vehicle from a remote computer; and
navigating the vehicle based at least in part on the vehicle pose.

18. The method of claim 17, further comprising determining whether data received from the remote computer includes the vehicle pose based on the displayed second set of content.

19. The method of claim 17, further comprising:
generating the second set of content based on a vehicle identifier;
decoding, in a remote computer, the vehicle identifier based on the received second set of content; and
including the vehicle identifier in the transmitted vehicle pose.

20. The method of claim 13, further comprising generating the second set of content based on vehicle diagnostics data.
